(19) United States
(12) Patent Application Publication
(10) Pub. No.: US 2007/0147785 A1
(43) Pub. Date: Jun. 28, 2007

(54) Method of detecting information break position of multiplexed stream, sound digital broadcast recording apparatus, and recording control method

(75) Inventor: Makoto Kusunoki, Akishima-shi (JP)

Correspondence Address: PILLSBURY WINTHROP SHAW PITTMAN, LLP, P.O. BOX 10500, MCLEAN, VA, 22102, US

(73) Assignee: KABUSHIKI KAISHA TOSHIBA, Tokyo (JP)

(21) Appl. No.: 11/582,302

(22) Filed: Oct. 18, 2006

(30) Foreign Application Priority Data
Dec. 26, 2005 (JP) 2005-373313

(51) Int. Cl. H04N 7/00

(52) U.S. Cl. 386/96

(57) ABSTRACT

A sound digital broadcast recording apparatus includes receiving means for receiving a multiplexed stream, stream separating means for separating the multiplexed stream received by the receiving means into sound data and a section, decoder means for decoding the sound data, recording means for recording the sound data, silence detecting means for detecting a silence portion in the decoded sound data, attribute setting means for setting attribute information of data to be automatically recorded by the recording means, attribute comparing means for comparing sound data attribute information included in the section with the attribute information set by the attribute setting means, and recording control means for determining whether the sound data is to be recorded or not based on a comparison result and causing the recording means to start recording from a silence detecting point.

### CROSS-REFERENCE TO RELATED APPLICATIONS

This application is based upon and claims the benefit of priority from Japanese Patent Application No. 2005-373313, filed Dec. 26, 2005, the entire contents of which are incorporated herein by reference.

### BACKGROUND

1. Field

This invention relates to a method of detecting an information break position of a multiplexed stream, a sound digital broadcast recording apparatus, and a recording control method, in particular, an improvement in processing of recording, for example, a designated tune in a broadcasting signal.

2. Description of the Related Art

Currently, tunes (objects) can be distributed in digital broadcasting programs. As receivers or recording apparatuses used in such situations, an apparatus which stores desired tunes in a storage medium (hard disk or semiconductor memory) has been developed (Jpn. Pat. Appln. KOKAI Pub. No. 2001-352517).

The object of the invention is to provide a method of detecting an information break position of a multiplexed stream, a sound digital broadcast recording apparatus, and a recording control method, which automatically store tunes desired by the user, without letting unnecessary data inserted before and after a desired recording program, by using attribute information of a program included in a broadcasting signal, and detection of a silent portion of an object.

### BRIEF DESCRIPTION OF THE SEVERAL VIEWS OF THE DRAWINGS

A general architecture that implements the various feature of the invention will now be described with reference to the drawings. The drawings and the associated descriptions are provided to illustrate embodiments of the invention and not to limit the scope of the invention.

FIG. 1 is a block diagram illustrating a configuration example of a sound digital broadcast receiving and recording apparatus according to a first of the invention.

FIGS. 2A, 2B and 2C are diagrams, each of which illustrates an example of a structure of MPEG2-TS in digital sound broadcasting.

FIG. 3 is a diagram illustrating an example of a structure of a TS header in the MPEG2-TS illustrated in FIG. 2.

FIG. 4 is a diagram illustrating an example of a structure of a sound PES of the MPEG2-TS illustrated in FIG. 2.

FIGS. 5A and 5B are diagrams, each of which illustrates an example of a structure of an EIT section of the MPEG2-TS illustrated in FIG. 2.

FIG. 6 is a diagram illustrating an example of multiplexing of the sound PES and the EIT section of the MPEG2-TS illustrated in FIG. 2.

FIG. 7 is a flowchart illustrating an example of automatic recording processing of a digital sound broadcast in a control section.

FIGS. 8A, 8B and 8C are timing charts, each of which illustrates generating a tune recording signal by using a tune attribute match signal and a silence detecting signal.

### DETAILED DESCRIPTION

Various embodiments according to the invention will be described hereinafter with reference to the accompanying drawings. In general, according to one embodiment of the invention, a method of detecting an information break position of a multiplexed stream, using receiving means for receiving a multiplexed stream, stream separating means for separating the multiplexing stream received by the receiving means into sound data and a section, and silence detecting means for detecting a silence period of a sound signal obtained by decoding the sound data, the method comprises detecting sound data attribute information included in the section and outputting a signal to set a break of the sound signal when the silence detecting means detects a next silence period.

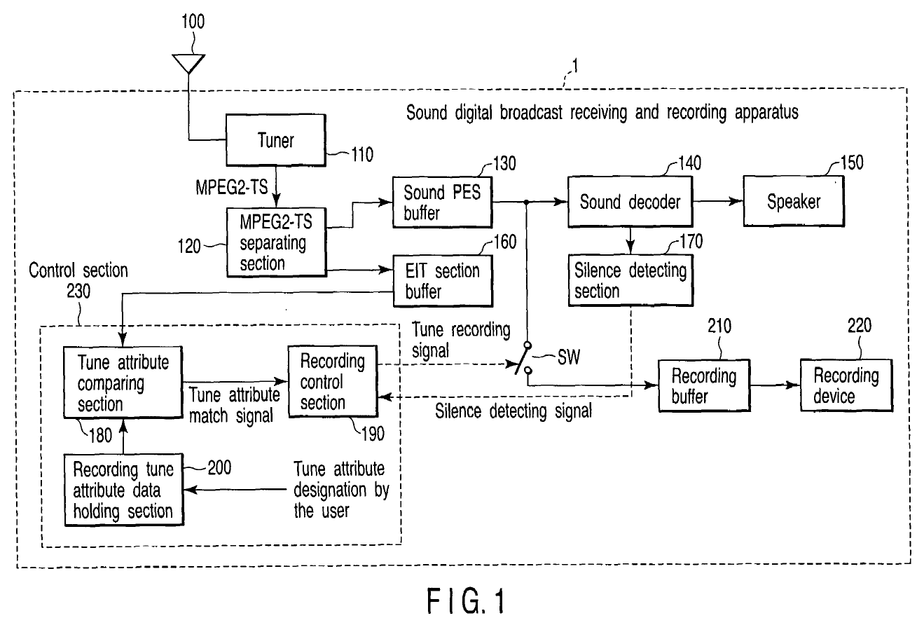

A sound digital broadcast receiving and recording apparatus according to a first embodiment of the invention is described below with reference to drawings. FIG. 1 is a block diagram illustrating a configuration example of a sound digital broadcast receiving and recording apparatus 1 according to the invention.

<Configuration and Function of each Section>

The sound digital broadcast receiving and recording apparatus 1 has an antenna 100. The antenna 100 receives digital sound broadcasting signals. The antenna 100 is connected to a tuner 110. The tuner 110 selects a desired channel from channels of the broadcasting signals received by the antenna 100. An output end of the tuner 110 is connected to an MPEG2-TS separating section 120 (MPEG: Moving Picture Expert Group, TS: Transport Stream). The MPEG2-TS separating section 120 separates, for example, a sound signal (sound PES), and attribute information (EIT section) included in multiplexed broadcasting signals, from the multiplexed broadcasting signals. One output terminal of the MPEG2-TS separating section 120 is connected to a sound PES buffer 130 (PES: Packetized Elementary Stream), and the other output terminal of the MPEG2-TS separating section 120 is connected to an EIT section buffer 160 (EIT: Event Information Table).

The sound PES buffer 130 temporarily stores sound data. An output terminal of the sound PES buffer 130 is connected to a sound decoder 140. The sound decoder 140 decodes sound signals into a format with which sound can be played back by a speaker 150.

The EIT section buffer 160 temporarily stores EIT sections containing attribute information such as tune titles and singer's names. An output terminal of the EIT section buffer 160 is connected to a tune attribute comparing section 180. The tune attribute comparing section 180 is connected with a recording tune attribute data holding section 200. An output terminal of the tune attribute comparing section 180 is connected to a signal input terminal of a recording control section 190.

Another output terminal of the sound decoder 140 is connected to a silence detecting section 170. The silence detecting section 170 detects a silent section of decoded sound signals. The silence detecting signal of the silence detecting section 170 is supplied to a signal input terminal of the recording control section 190.

A tune recording signal of the recording control section 190 is connected to a control terminal of a switch SW. The output terminal of the sound PES buffer 130 is connected to a recording buffer 210 through the switch SW. The recording buffer 210 is connected a recording device 220.

The recording tune attribute data holding section 200 stores attribute information set by the user, such as tune titles and singer's names, of tunes to be recorded. The tune attribute comparing section 180 compares the received attribute information supplied from the EIT section buffer 160 with the set attribute information set in the recording tune attribute data holding section 200. The recording control section 190 controls ON/OFF of the switch SW, in response to a comparison result of the tune attribute comparing section 180.

The switch SW connects and disconnects the sound PES buffer 130 to and from the recording buffer 210. The recording buffer 210 temporarily stores data to be recorded on the recording device 220.

Each section in the sound digital broadcast receiving and recording apparatus 1 is supplied with a control signal of the control section 230 (not shown). The control section 230 includes the tune attribute comparing section 180, the recording control section 190, and the recording tune attribute data holding section 200. The control section 230 controls functions of the sections in the sound digital broadcast receiving and recording apparatus 1.

<Operation>

When the antenna 100 receives broadcasting signals, the tuner 110 selects a desired broadcasting signal from the received broadcasting signals, and outputs the selected broadcasting signal to the MPEG2-TS separating section 120. The MPEG2-TS separating section 120 separates the supplied multiplexed broadcasting signal into a sound signal (sound PES) and attribute information (EIT section). The sound PES is output to the sound PES buffer 130, the EIT section is output to the EIT section buffer 160, and they are temporarily stored in the respective buffers. The sound decoder 140 decodes the sound PES, and reproduces the sound through the speaker 150. Simultaneously, the sound decoder 140 outputs the decoded sound data to the silence detecting section 170. The silence detecting section 170 transmits a silence detecting signal indicating silence to the recording control section 190.

The EIT section buffer 160 outputs the EIT section to the following tune attribute comparing section 180. In the recording tune attribute data holding section 200, attribute information items of a plurality of tunes to be recorded are set by the user. The tune attribute comparing section 180 compares the attribute information from the EIT section with the attribute information items set in the recording tune attribute data holding section 200. If there is an attribute information item matching the attribute information from the EIT section as a result of comparison, the tune attribute comparing section 180 transmits a tune attribute match signal to the recording control section 190.

The recording control section 190 generates a tune recording signal by using the tune attribute match signal and the silence detecting signal, and thereby controls the switch SW. When the switch SW is closed, a sound PES is output from the sound PES buffer 130 to the recording buffer 210, and temporarily stored therein. The sound PES stored in the recording buffer 210 is thereafter stored in the recording device 220. Further, in this process, the recording control section 190 obtains a determination result indicating that the attribute information match, and outputs a signal to set a break of recording information when the silence detecting section 170 detects the next silence. Then, the signal is stored, as a break mark of the recording information, in the recording device 220 together with the recording information. This facilitates search between tunes and jump, by detecting a break mark in playback of sound data.

In the above explanation, the tune attribute comparing section 180 compares the attribute information from the EIT section with the attribute information items set in the recording tune attribute data holding section 200 and, if a matching attribute information item is found as a result of comparison, transmits a tune attribute match signal to the recording control section 190. However, the most prominent feature of the invention resides in detecting the transmitted tune attribute information, and outputting a signal to set a break of a sound signal when the silence detecting section 170 detects the next silence period. Specifically, the invention uses both detection of the attribute information and detection of a silence period, and thus achieves stable identification of a break position of sound signals and the like. Adopting this structure enables storing of a signal to set a break of a sound signal, as a break mark of recording information, in the recording device 220 together with the recording information.

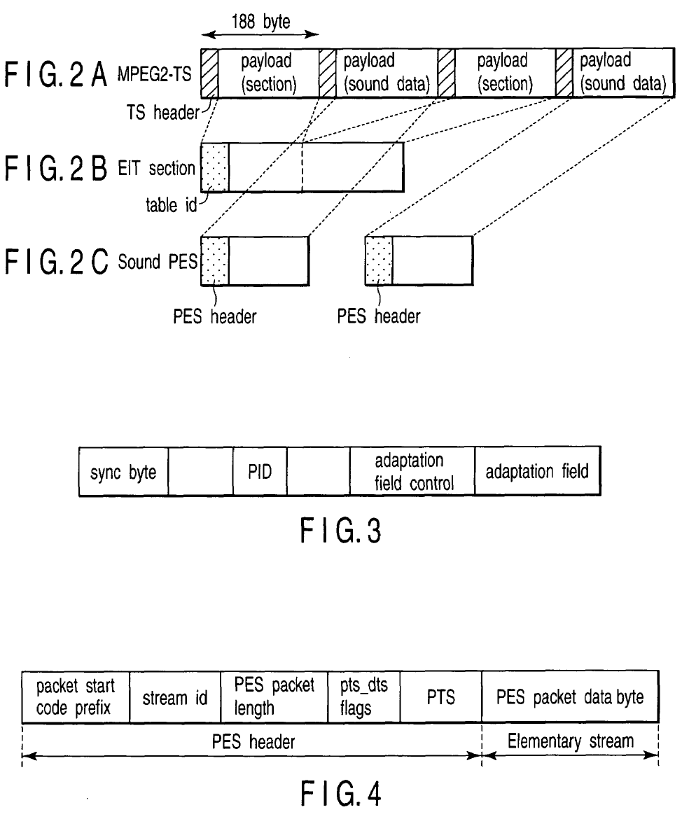

Each of FIGS. 2A, 2B and 2C is a diagram illustrating an example of a structure of MPEG2-TS in digital sound broadcasting. MPEG2-TS of FIG. 2A is formed of a series of packets each having 188 bytes. The sound PES and EIT sections are stored in a divided manner in payloads of the series. A TS header and one payload form one packet.

FIG. 2B illustrates an EIT section in an MPEG2-TS, separated by the MPEG2-TS separating section 120. At the head, there is an ID called table ID, which is determined by the type of the section.

FIG. 2C illustrates a sound PES 2 in the MPEG2-TS, separated by the MPEG2-TS separating section 120. To the head of each sound PES 2, provided is a PES header including control information concerning playback of sound data.

FIG. 3 is a diagram illustrating an example of a structure of the TS header of the MPEG2-TS illustrated in FIG. 2A. The TS header includes at least a sync byte, a PID (packet ID), an adaptation field control, and an adaptation field.

The sync byte indicates the head of the TS packet. The PID is an identification number provided according to the type of the sound PES or the EIT section. Data of the TS packet is identified on the basis of the PID. Specifically, the MPEG2-TS separating section 120 separates MPEG2-TS on the basis of PID.

The adaptation field is a header extension section to control the size of payload. The adaptation field control indicates the state of the adaptation field.

FIG. 4 is a diagram illustrating an example of a structure of the sound PES of the MPEG2-TS illustrated in FIG. 2C. The sound PES is formed of a PES header, and an elementary stream being compressed and encoded sound data. The PES header includes at least a packet start code prefix, a stream ID, a PES packet length, pts_dts flags, and a PTS (Presentation Time Stamp).

The packet start code prefix is a start code indicating the head of the PES packet. The stream ID is an identifier indicating the type of the PES packet. The PES packet length indicates the length of the PES packet. The length of the packet is a length from the PES packet length field to the end of the PES packet.

The PTS indicates the time when playback of the packet is started. The PTS DTS flags are flags indicating presence and absence of PTS and DTS. The DTS (Decoding Time Stamp) indicates the time when decoding of the packet is started.

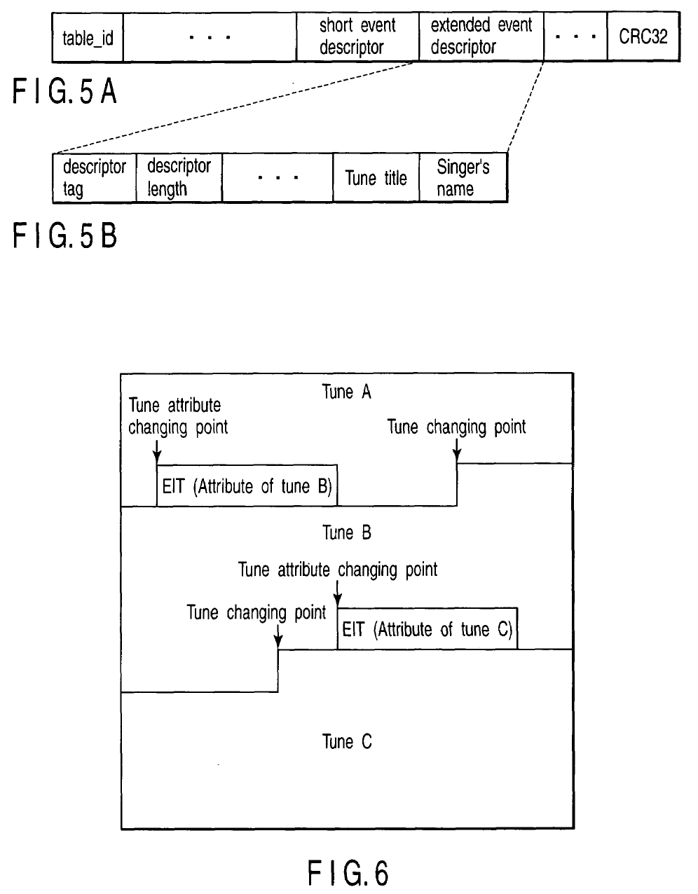

FIG. 5 is a diagram illustrating an example of a structure of the EIT section of the MPEG2-TS illustrated in FIG. 2. Although there are a plurality of types of sections which can be multiplexed with MPEG2-TS in digital sound broadcasting, their structures are basically the same. A general section includes at least a table ID, a descriptor, and a CRC 32 (Cyclic Redundancy Check 32).

The table ID is an identifier indicating the type of the section. A descriptor of data in the payload is described in a field of the descriptor. The CRC32 insures the correctness of the data.

Further, in the EIT section according to the invention, the descriptor is formed of a short event descriptor and an extended event descriptor. The extended event descriptor further includes a descriptor tag, a descriptor length, and attribute information such as tune titles and singer's names.

The short event descriptor is similar to general section descriptors. The descriptor tag indicates the head of the extended event descriptor. The descriptor length indicates the length from the field thereof to the end of the extended event descriptor. Thereafter, attribute information such as tune titles and singer's names is described.

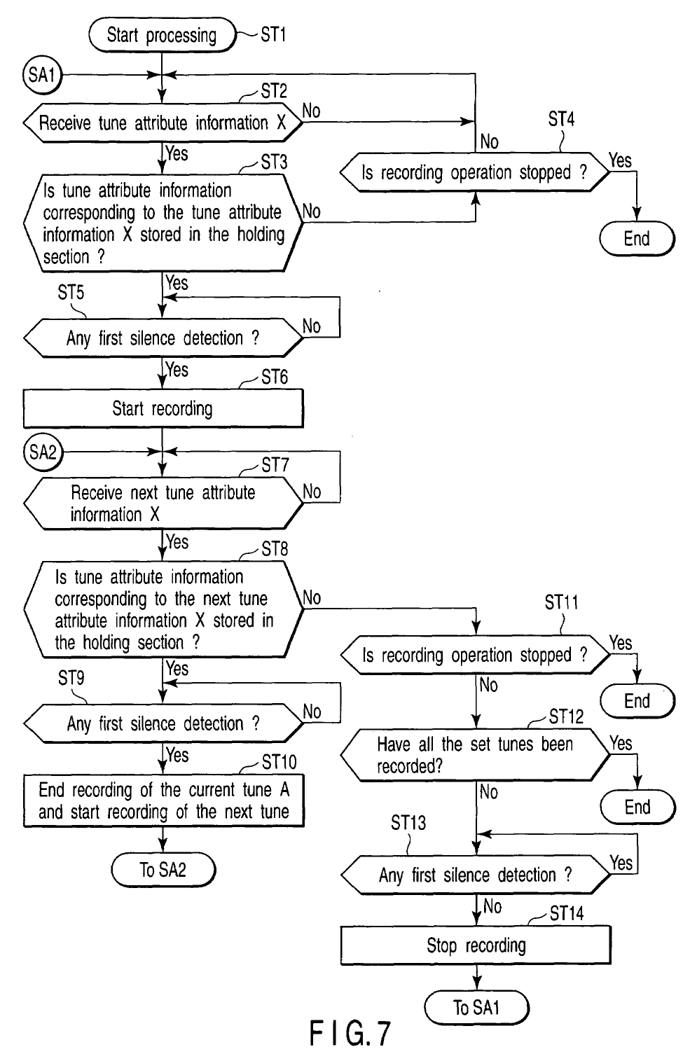

FIG. 6 is a diagram illustrating an example of multiplexing the sound PES and the EIT section of the MPEG2-TS illustrated in FIGS. 2A, 2B and 2C. Tune A, tune B, and tune C are sound data included in the elementary stream of the sound PES. The EITs for the tunes are sent prior to respective corresponding tunes. Specifically, an EIT for the tune B is included in the stream of the tune A. Therefore, EIT is sent slightly prior to the actual tune changing point.

A tune attribute changing point indicates a point where the descriptor tag included in the extended event descriptor has been received. A tune changing point indicates a point where the silence detecting section 170 has detected a silence portion in decoding the sound PES.

Specifically, while the tune A is recorded, an EIT section including the attribute information of the following tune B is received. Further, recording of the tube B is started from a tune changing point (first silence portion).

This is because the EIT section is superposed such that the EIT section is received prior to changing of sound data, in consideration of time lag in operation of the receiver.

FIG. 7 is a flowchart illustrating an example of automatic recording processing of digital sound broadcast in the control section 230. Suppose that the attribute information of a tune which the user wishes to record is set in the recording tune attribute data holding section 200, and thereby processing is started (step ST1).

When the control section 230 receives tune attribute information X (step ST2), the tune attribute information X is supplied to the tune attribute comparing section 180, and next the control section 230 checks whether set attribute information corresponding to the attribute information X is set in the recording tune attribute data holding section 200 or not (step ST3). When there is no set attribute information corresponding to the attribute information X, the control section 230 checks whether the recording operation is stopped or not (step ST4), and returns to step ST2.

When corresponding attribute information is detected in step ST3, the recording control section 190 waits for notification of a first silence detecting signal from the silence detecting section 170 (step ST5). When a silence detecting signal is received, the recording control section 190 closes the switch SW, and starts recording of the tune A to the recording device 220 (step ST6).

Next, the control section 230 waits for next tune attribute information X, while performing recording (step ST7). When the next tune attribute information X is received (step ST7), the control section 230 checks whether set attribute information corresponding to the attribute information X is set in the recording tune attribute data holding section 200 (step ST8).

When corresponding attribute information is detected, the recording control section 190 waits for notification of a first silence detecting signal after the detection (step ST9). When a silence detecting signal is received, the recording control section 190 ends recording of the current tune (for example, the tune A), and starts recording of the next tune (for example, the tune B) (step ST10). Then, the control section 230 returns to step ST7, and waits for reception of the next tune attribute information. The above routine including steps ST7, ST8, ST9, and ST10 is performed when tunes A and B desired by the user are successively received.

In step ST8, when there is no set attribute information corresponding to the received tune attribute information X, the control section 230 goes to step ST11, and checks whether the recording operation is stopped or not. When the recording operation is stopped, the control section 230 ends the processing. When the recording operation is not stopped, the control section 230 goes to step ST12, and checks whether all the set tunes have been recorded or not. When all the set tunes have been recorded, the control section 230 ends the processing. When all the set tunes have not been recorded, the control section 230 performs recording stop processing of the recorded tune when it receives a first silence detection signal, and returns to the step ST2.

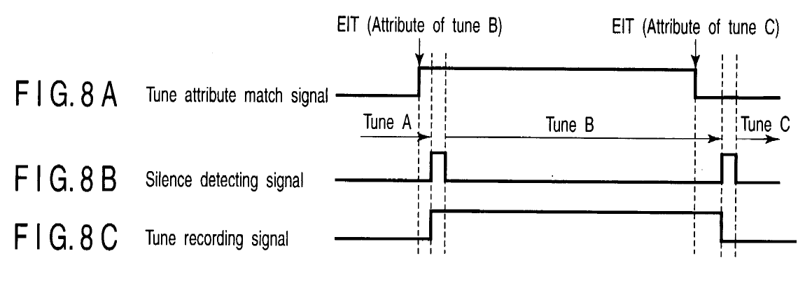

Each of FIGS. 8A, 8B and 8C is a timing chart of generating a tune recording signal by using a tune attribute match signal and a silence detecting signal. FIG. 8 illustrates start and end of recording of the tune B.

Signal of FIG. 8A is a tune attribute match signal transmitted from the tune attribute comparing section 180 to the recording control section 190. A high level state of the signal indicates that the tune attribute match signal for the tune B is being sent. Signal of FIG. 8B is a first silence detecting signal transmitted from the silence detecting section 170 to the recording control section 190. The term “first” means a signal first transmitted after tune attribute detection. A high level state of the signal indicates that the silence detecting signal is being sent. Signal of FIG. 8C is a tune recording signal transmitted from the recording control section 190 to control the switch SW. A high level state of the signal indicates that the tune recording signal is being sent and the switch SW is closed.

Suppose that attribute information corresponding to the attribute information of the tune B is set in the recording tune attribute data holding section 200. When an EIT section including the attribute information of the tune B is received, the tune attribute match signal of FIG. 8A becomes a high state, and a tune attribute match signal is transmitted. When a first silence detecting signal of FIG. 8B becomes a high state in the state where the tune attribute match signal is being provided to the recording control section 190, a tune recording signal of FIG. 8C is transmitted, and the apparatus comes to the state where recording processing is performed. Thereby, recording of the tune B is started.

Next, an EIT section including the attribute information of the tune C is received. However, since no corresponding attribute information is detected, the tune attribute match signal of FIG. 8A becomes a low state. Then, when a first silence detecting signal FIG. 8B becomes a high state next time, the tune recording signal of FIG. 8C becomes a low state, and thereby recording processing is ended.

As described above, when a tune of digital sound broadcasting is recorded, attribute information of the tune is used for determining whether recording is to be performed or not, and recording is started from a point of detecting silence. This structure enables recording of user's desired tunes with high quality without omission or unnecessary data.

The invention is not limited to the above embodiment. For example, a plurality of attribute information items may be set and setting them do not affect carrying out of the present invention, as long as they are included in MPEG2-TS.

Further, although start and end of recording is detected by using a silence detecting point, the invention is not limited to it. Any means indicating changing of objects can be used and fall within the range of the gist of the invention.

Furthermore, the object of the invention is not limited to recording of tunes of digital sound broadcasting. The invention can be carried out by using similar means, even if contents of objects are images.

While certain embodiments of the inventions have been described, these embodiments have been presented by way of example only, and are not intended to limit the scope of the inventions. Indeed, the novel methods and systems described herein may be embodied in a variety of other forms; furthermore, various omissions, substitutions and changes in the form of the methods and systems described herein may be made without departing from the spirit of the inventions. The accompanying claims and their equivalents are intended to cover such forms or modifications as would fall within the scope and spirit of the inventions.

What is claimed is:

1. A method of detecting an information break position of a multiplexed stream, using receiving means for receiving a multiplexed stream, stream separating means for separating the multiplexing stream received by the receiving means into sound data and a section, and silence detecting means for detecting a silence period of a sound signal obtained by decoding the sound data, the method comprising:
detecting sound data attribute information included in the section; and
outputting a signal to set a break of the sound signal when the silence detecting means detects a next silence period.

2. A method according to claim 1, wherein
the signal to set the break of the sound signal is a break mark of recording information, and the break mark is recorded by recording means together with the recording information.

3. A sound digital broadcast recording apparatus comprising:
receiving means for receiving a multiplexed stream;
stream separating means for separating the multiplexed stream received by the receiving means into sound data and a section;
decoder means for decoding the sound data;
recording means;
attribute setting means for setting a plurality of attribute information items of data to be automatically recorded by the recording means;
attribute comparing means for comparing sound data attribute information included in the section with the attribute information items set by the attribute setting means, and determining whether the attribute information items includes an attribute information item matching the sound data attribute information;
silence detecting means for detecting a silence portion in the decoded sound data; and
recording control means for causing the recording means to start recording when the attribute comparing means obtains a determination result that the sound data attribute information matches one of the attribute information items and the silence detecting means detects a next silence, and to stop recording when the silence detecting means detects a next silence when the recording means is performing recording.

4. A sound digital broadcast recording apparatus according to claim 3, wherein
the sound data follows the attribute information in the multiplexed stream.

5. A sound digital broadcast recording apparatus according to claim 3, wherein
the section further includes a plurality of attribute information items concerning the sound data.

6. A sound digital broadcast recording apparatus according to claim 3, wherein
the recording control means includes means for controlling a switch provided between the decoder means and the recording means.

7. A recording control method used in a sound digital broadcast recording apparatus including receiving means for receiving a multiplexed stream, stream separating means for separating the multiplexed stream received by the receiving means into sound data and a section, decoder means for decoding the sound data, recording means for recording the sound data, attribute setting means for setting attribute information of data to be automatically recorded by the recording means, the method comprising:
comparing sound data attribute information included in the section with the attribute information set by the attribute setting means,
detecting whether the decoded sound data includes a silence portion when the compared attribute information match; and
causing the recording means to start recording when the silence portion is detected, and to end recording when a next silence is detected without reception of new attribute information while recording.

8. A recording control method according to claim 7, wherein
recording of a current tune is ended and recording of a next tune is started at a next silence detecting point, when new attribute information is received during recording and the new attribute information matches the attribute information set in the attribute setting means.
